(19) United States
(12) Patent Application Publication
(10) Pub. No.: US 2025/0216257 A1
(43) Pub. Date: Jul. 3, 2025

(54) OPTICAL COMPONENT AND SYSTEM FOR SIMULTANEOUS 3D HYPERSPECTRAL IMAGING

(71) Applicant: HI-Spectral, LLC, Kula, HI (US)

(72) Inventor: Haosheng LIN, Kula, HI (US)

(73) Assignee: HI-Spectral, LLC, Kula, HI (US)

(21) Appl. No.: 19/004,208

(22) Filed: Dec. 27, 2024

Related U.S. Application Data
(60) Provisional application No. 63/616,012, filed on Dec. 29, 2023.
(60) Provisional application No. 63/713,372, filed on Oct. 29, 2024.

(51) Int. Cl. G01J 3/18; G01J 3/02; G01J 3/28

(52) U.S. Cl. CPC G01J 3/1804; G01J 3/0208; G01J 3/021; G01J 3/0259; G01J 3/2823

(57) ABSTRACT

A machined image slicer compact spectrograph (MICS) for use with a multispectral light source includes a two-mirror integral field unit and a micro spectrograph array. The integral field unit includes an image slicer having a plurality of slicer mirrors to receive light from the multispectral light source and output a plurality of diverging light beams and a plurality of reimaging mirrors to output an image of each slicer mirror onto an exit slit mask containing a plurality of exit field stops, one for each of the image of the slicer mirrors. The micro spectrograph array includes a plurality of powered optics receiving light from the plurality of exit field stops and a plurality of powered diffraction grating to output an image of each slicer mirror onto an image sensor.

### CROSS REFERENCE TO RELATED APPLICATIONS

The present application claims priority to U.S. Provisional application No. 63/616,012 filed in the Dec. 29, 2023, and U.S. Provisional application No. 63/713,372filed in the Oct. 29, 2024, the entire contents of which are incorporated herein by reference.

### FIELD

The present disclosure relates to optical components and systems for simultaneous, real-time 3-dimensional (two spatial [x,y] and one spectral [lambda]) hyperspectral imaging of a 2-dimensional spatial field.

### DESCRIPTION OF THE RELATED ART

In many areas of business and science, cameras are used which, in addition to a spatial resolution, have a spectral resolution that often goes beyond the red, green, and blue bands that human eyes can perceive. Spectrally high-resolution imaging technology, which is referred to as “hyperspectral imaging”, has been developed for these measurements. This hyperspectral imaging allows, for example, recognition and differentiation of different chemical elements based on the spatially resolved spectrum.

Early hyperspectral imaging systems based on long-slit diffraction grating (or any dispersive elements such as prisms) spectrograph used a so-called “push broom” scanning, in which one dimension is used for a spatial determination and the other dimension for a spectral determination on a two-dimensional image sensor. New approaches in hyperspectral imaging and the development of higher-resolution sensors and computer hardware have made snapshot full-frame hyperspectral systems possible.

Conventional hyperspectral imagers, also known as Integral Field Spectrographs (IFS), are composed of two parts: 1) an Integral Field Unit (IFU) that reformats a two-dimensional (2D) spatial field formed by an imaging system such as a telescope, a camera lens, or a microscope into long narrow slices or sparsely populated 2D field of light sources, and 2) a conventional grating spectrograph coupled with 2D sensor to record the spectra of all of the field points simultaneously. Three types of IFUs, namely, 1) microlens arrays, 2) coherent fiber optic arrays, and 3) machined or polished glass image slicers are commonly used for the construction of IFSs, each with their advantages and limitations. The optical systems of the spectrographs of conventional IFS are usually large due to the need to support the extended long slit or the large sparsely populated small light sources formed by the IFUs. Due to the large spectrographs, the intrinsic spectral resolution these spectrographs (limited by the illuminated size of the grating) can achieve usually far exceeds the resolution required.

### SUMMARY

One or more embodiments are directed to optical components and systems for snapshot hyperspectral imaging in a compact structure.

One or more embodiments is directed to a machined image slicer compact spectrograph (MICS) for use with a multispectral light source includes a two-mirror integral field unit and a micro spectrograph array. The integral field unit includes an image slicer having a plurality of slicer mirrors to receive light from the multispectral light source and output a plurality of diverging light beams and a plurality of reimaging mirrors to output an image of each slicer mirror onto an exit slit mask containing a plurality of exit field stops, one for each of the image of the slicer mirrors. The micro spectrograph array includes a plurality of powered optics receiving light from the plurality of exit field stops and a plurality of powered diffraction grating to output an image of each slicer mirror onto an image sensor.

The plurality of slicer mirrors may be spherical mirrors with a variable radius of curvature. The plurality of slicer mirrors may be cylindrical mirrors with a variable radius of curvature in a horizontal direction.

Each slicer mirror of the plurality of slicer mirrors may form a micro pupil in between the slicer mirrors and the reimaging mirrors.

Each of the plurality of reimaging mirrors may be an off-axis parabolic reimaging mirror. Each slicer mirror of the plurality of slicer mirrors form a micro pupil at a focus of a corresponding off-axis parabolic reimaging mirror of the plurality of off-axis parabolic reimaging mirrors. Each slicer mirror of the plurality of slicer mirrors may form a micro pupil on the corresponding off-axis parabolic reimaging mirror the plurality of off-axis parabolic reimaging mirrors.

The MICS may include a plurality of field lenses placed at the images of each slicer mirror to condition the beams toward the micro spectrograph array. The plurality of field lenses may have variable curvatures each optimized for each beam. The plurality of field lenses may be biconic lenses with variable curvatures each optimized for each beam.

Each powered diffractive grating of the plurality of powered diffractive gratings may be a toroidal grating.

Each exit field stop of the plurality of exit field stops may be an exit slit. Each exit field stop of the plurality of exit field stops may be an exit field lens.

The two-mirror integral field unit may be an immersive integral field unit or a free-space integral field unit. The immersive integral field unit may be monolithic and on a transparent substrate.

The micro spectrograph array may be a free-space spectrograph, a transmissive spectrograph, or a cross dispersed spectrograph. In the free-space spectrograph, each of the plurality of powered optics may be a fold mirror. Each of the plurality of fold mirrors may be concave in the spectral direction and convex in the spatial direction. Each powered diffractive grating of the plurality of powered diffractive gratings is a toroidal grating.

### BRIEF DESCRIPTION OF THE DRAWINGS

The scope of the present disclosure is best understood from the following detailed description of exemplary embodiments when read in conjunction with the accompanying drawings.

FIG. 1 is a perspective ray trace view and FIG. 2 is a perspective schematic view of a machined image slicer integral field unit (MISI) according to an embodiment.

FIG. 3 is a perspective isometric view of an image slicer according to an embodiment.

FIG. 4 is a perspective schematic view of a machined image slicer compact spectrograph (MICS) according to an embodiment.

FIG. 5 is a perspective view of the MICS according to an embodiment.

FIG. 6 is a perspective ray trace view of the MICS for the chief ray of a single beam.

FIGS. 7-9 are different perspective views of the MICS chief rays for all beams.

FIG. 10 is a side schematic view of the MICS for all beams.

FIG. 11 is a top schematic view of the MICS for all beams.

FIG. 12 is a perspective ray trace view of a configuration having four MICS sharing a common light feed according to an embodiment.

FIG. 13 is a perspective schematic view of a configuration having a plurality of MICS each with dedicated light feed according to an embodiment.

FIG. 14 is a perspective schematic view of a MICS according to an embodiment.

FIG. 15 is a perspective ray trace view of the MICS of FIG. 14 for the chief ray of a single beam.

FIG. 16 is a top schematic view of the MICS of FIG. 14.

FIG. 17 is perspective views of the MICS chief rays of FIG. 14 for all beams.

FIG. 18 is a perspective view of a portion of FIG. 17 of or all beams.

FIG. 19 is a perspective view of a portion of FIG. 17 for all beams.

FIG. 20 is a perspective schematic view of a MICS according to an embodiment.

FIG. 21 is a perspective top schematic view of the MICS of FIG. 20.

FIG. 22 is a perspective view of FIG. 20 of the MICS of FIG. 20 for all beams.

FIG. 23 is a perspective view of an transmissive MICS (tMICS) according to an embodiment.

FIG. 24 is a top schematic view of the tMICS of FIG. 23.

FIG. 25 is a perspective view of an transmissive MISI (tMISI) used in FIG. 23.

FIG. 26 is a perspective view of a grating lens array of FIG. 23.

### DETAILED DESCRIPTION

An integral field unit is an optical device that divides a 2D spatial field into a 2D array of image elements (pixels) or long narrow slices and using a reimaging system to reformat the spatial field into a field of sparsely populated point sources or long slits to form the input source, commonly referred to as the ‘entrance slit’ of diffraction grating spectrograph, for injection into a diffraction spectrograph for use with a multispectral light source.

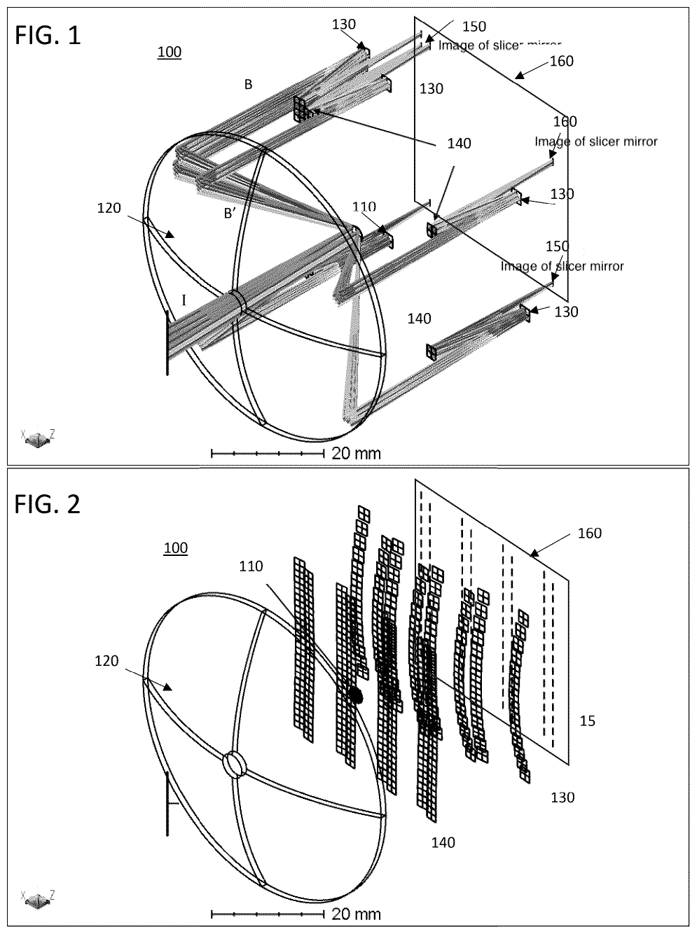

As shown in FIGS. 1 and 2, a machined image slicer integral field unit (MISI) 100 includes a machined image slicer 110, an image slicer 110 that includes a plurality of slicer mirrors 115, a collimator mirror 120, a plurality of fold mirrors 130, a plurality of reimaging mirrors 140, and an exit field stop or array of exit slits, i.e., an exit port 150, having a corresponding plurality of images of slicer mirrors 115, which are then output to a focal plane array 160 at a sensor. Thus, the reimaging system of MISI 100 is a four mirror design, i.e., slicer mirrors 115, fold mirrors 130 between the collimator mirror 120 and the reimaging mirror 140.

The plurality of slicer mirrors 115 in the image slicer 110 reflects an incoming beam I into a plurality of diverging beams B′ to the collimator mirror 120, which, in turn, collimates these diverging beams B′ into collimated beams B and directs the collimated beams B onto a corresponding one of the fold mirrors 130. Light output from each fold mirror 130 is reflected and focused by a corresponding one of the reimaging mirrors 140 to image each slicer mirror 115 at and through each exit slit 150.

In particular, each of the micro slicer mirror 115 is reimaged to a designated position in the exit port 150 using the collimator mirror 120, e.g., an off-axis parabolic collimator mirror, to collimates the diverging beam from the slicer mirror 115 followed by a corresponding fold mirror 130, e.g., a micro flat fold mirror, and reimaging mirror 140, e.g., a micro spherical mirror, to refocus onto the focal plane array. In particular, each reimaging mirror 140 may be approximately one focal length away from the intermediate pupils for each collimated beam B formed by the parabolic collimator mirror 120, such that the exit beams are effectively telecentric.

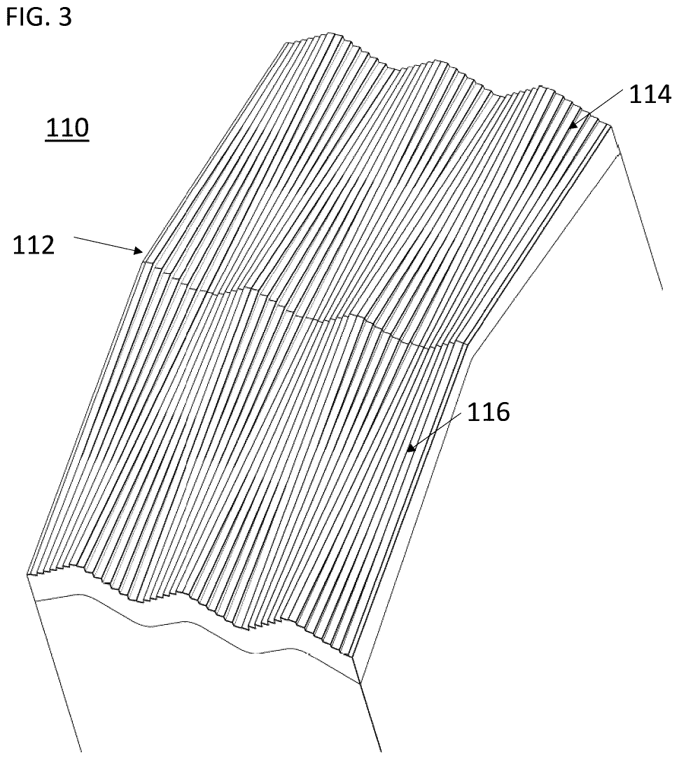

As may be seen in FIG. 3, the image slicer 110 is divided into two sections defined by a ridge 112. The slicer mirrors 115 include a first plurality of slicer mirrors 114 and a second plurality of slicer mirrors 116 divided by the ridge 112. The first plurality of slicer mirrors 114 have a general tilt angle to direct the beams upward, and the second plurality of slicer mirrors 116 have a general tilt angle in the opposite direction of the general tilt angle of the first plurality of slicer mirror to direct the beam downward. The division of the image slicer into two sections reduce the depth of the valleys each of the section. The valleys of a conventional image slicer, i.e., an image slicer without the ridge, would have to be very deep, rendering the image slicer impractical to manufacture. However, by including the ridge 112, depth of the valleys may be reduced. The ridge 112 allows the image slicer 110 to direct images of the slicer mirrors 116 to different fold mirror 130/reimaging mirror 140 configurations arranged in an array. The particular design of the image slicer 110 depends on the arrangement of these other components of the MISI 100 and uses the ridge 112 to keep the angle small, as well a focal plane size of the sensor.

In a particular example, the image slicer 110 may include 56×2 slicer mirrors, e.g., each with a dimension of 0.036 mm×2.664 mm, to divide the field into a total of 112 subfields (only 6 of which are shown for clarity). The design of the image slicer 110 depends on the downstream configuration and could include additional sections with additional ridge(s).

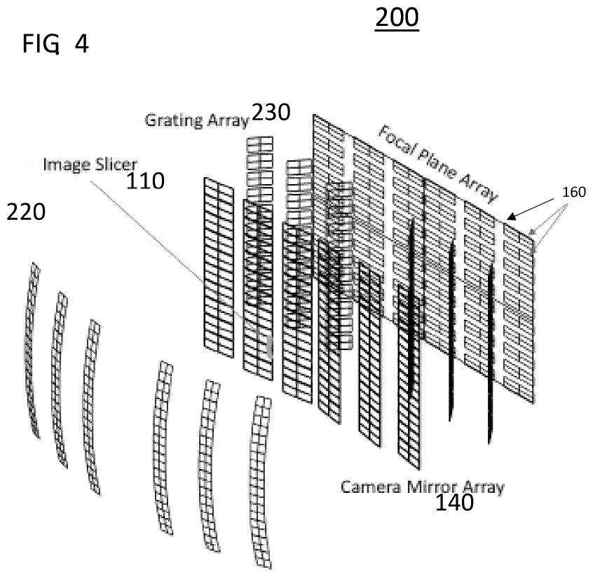

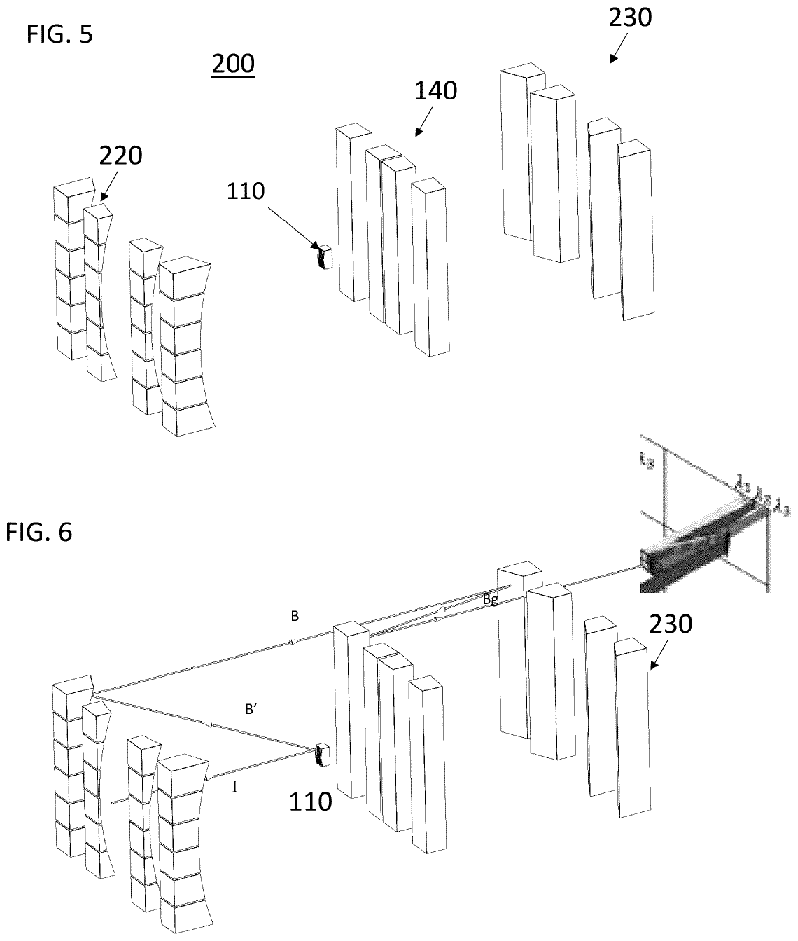

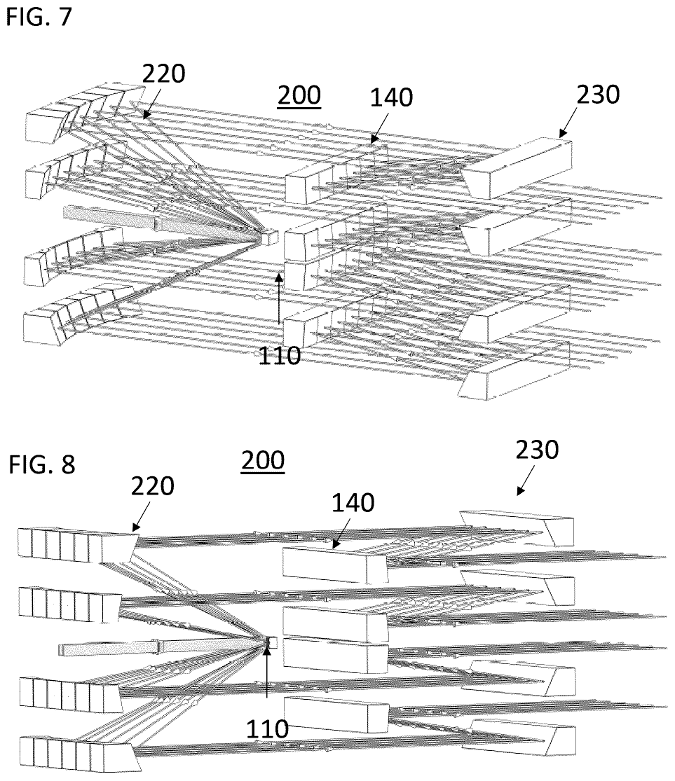

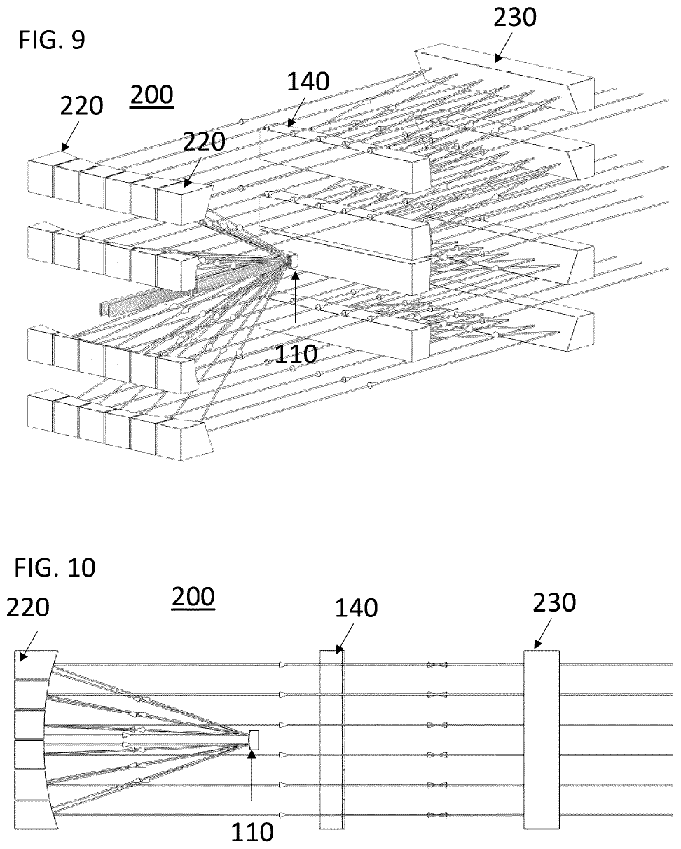

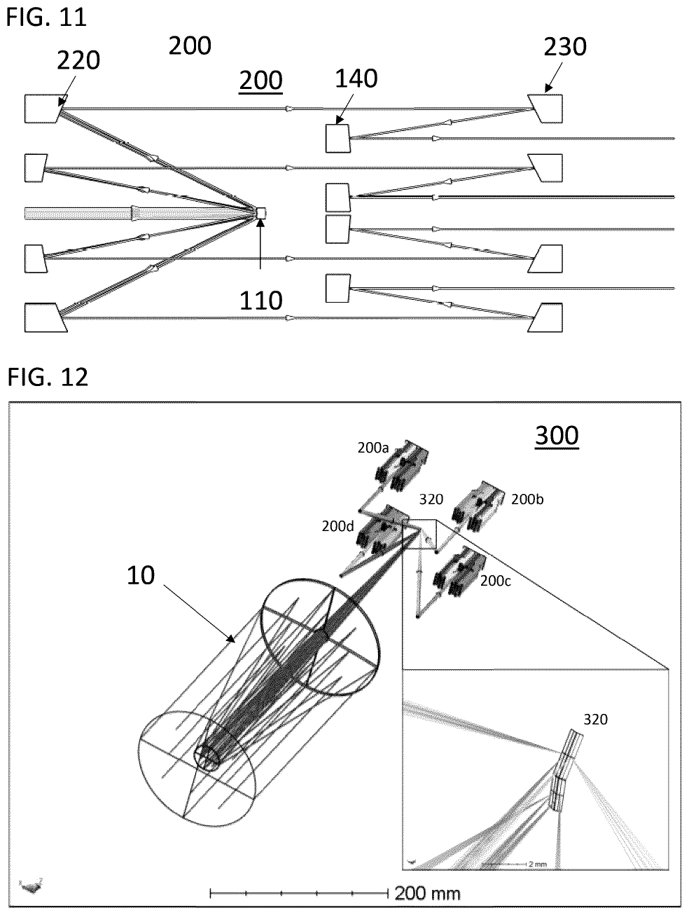

A machined image slicer compact spectrograph (MICS) 200 according to an embodiment is illustrated in FIGS. 4 to 11. FIGS. 4 and 6 are rotated from the actual configuration which is illustrated in FIGS. 7 to 11 for better visualization of the array. As may be seen therein, the MICS 200 uses the machined image slicer 110 design and the reimaging system of the MISI 100, but replaces the common collimator mirror 120 with individual collimator mirrors and the fold mirrors 130 with gratings. Thus, the integral field unit of the MISI 100 is converted into a mini-spectrograph array of the MICS 200. By incorporating the gratings directly into the integral field unit, the MICS design eliminates the need to have a large, common spectrograph behind the integral field unit, thereby greatly reducing the size of an integral field spectrograph. The following describes optical designs of MICS according to different configurations, one with a single MICS, and one with four MICS to demonstrate the flexibility and scalability of this design.

The MICS 200 includes the image slicer 110 that includes the plurality of slicer mirrors 115, a plurality of off-axis parabolic mirrors (OAPs) 220, a plurality of micro-gratings 230, a plurality of reimaging mirrors 140, and a focal plane array 160. As may be seen in FIG. 4, the plurality of slicer mirrors 115 in the image slicer 110 reflects an incoming beam I into a plurality of diverging beams B′ to each of the plurality of OAPs 220, which, in turn, collimate these beams B′ into collimated beams B and direct the collimated beams B onto a corresponding one of the gratings 130.

As may be seen in the inset of FIG. 6, the micro-gratings 230 diffract each of the collimated beams B into a plurality of constituent light beams λ1 to λn, e.g., three (red, green, blue) for white light, which are then separately focused as beam Bg on the focal plane array 160. Light output from the micro-gratings 230, here, reflective gratings, are reflected by a corresponding reimaging mirror 140 towards the focal plane array 160. Again, the particular design of the image slicer 110 will be dictated by the arrangement of these other components of the MICS 200 as well a focal plane size of the sensor.

Replacing the fold mirrors 130 with gratings 230 converts each of the 4-mirror reimaging system of MISI 100 into a mini spectrograph. Further, while the reimaging system of MISI 100 has a common parabolic collimator mirror 120, which results in a variable reflecting angle between the incident and outgoing beam on the fold mirrors 130, the MICS 200 uses individual off-axis parabolic mirrors 220 with the apex of the parent parabola located at the center of the corresponding slicer mirror to collimate the beam reflected by each of the slicer mirrors 115. This design makes the collimated beams from each of the slicer mirrors 115 to propagate toward each of the corresponding micro grating 230 in parallel to maintain a constant reflection angle (or the spectrograph angle) for all the mini spectrographs. Thus, an individual MICS 200 shown in FIGS. 4 to 10 includes an array of spectrographs, one for each slicer mirror 115 of the image slicer 110.

As may be seen in the particular example shown in FIGS. 4-11, the image slicer 110 may include a 12×2 slicer mirrors, e.g., each 20 μm×0.84 mm in size, forming a 4×6 array of spectrographs, as may be seen most clearly in FIG. 4. All of the mini spectrographs may have an identical grating a angle and spectrograph angle ψ=α−β, where α is the incident angle of the beam of the micro-gratings 230 with respect to the grating normal and β is the exit angle of the diffracted beam with respect to the grating normal. All the micro-gratings may have the same blazing angle. In this particular example, each micro-grating may be grouped as part of a grating 235, each grating 235 containing the 14 micro gratings for the 14 mini spectrographs in the row. Further, as may be seen therein, the individual collimator mirrors 220, the individual gratings 230, and the individual reimaging mirrors 140 may be each be integrated along one direction in the array, here a row direction.

MICS 200 is designed to utilize modern large-format focal plane arrays (FPAs) with large multiplexing capability to obtain high quality spectral information over a 2D field simultaneously in a compact space. Given a FPA with certain physical size and pixel format, the instantaneous spatial and spectral sampling size and the hyperspectral field of view (nx, ny, nλ) can be adjusted depending on the requirements of the measurements. For example, larger size optics can be used to achieve higher spectral resolution. However, this will reduce the number of mini spectrographs that can be accommodated on the sensor and the instantaneous spatial field of view coverage of the IFS. Nevertheless, the compact size of MICS allows multiple MICSs to be used in a single instrument, allowing the field of view to be easily doubled or quadrupled, as illustrated in FIG. 12.

FIG. 12 shows an example system 300 including four MICSs 200a to 200d fed by a common source, e.g., a telescope 10. A 2×2 field divider 320 divides the telescope focal plane into four subfields, one for each MICS. The inset in FIG. 12 illustrates details of the field divider 320. Four 2-lens folded relay systems direct the four subfields onto respective ones of the four MICSs 200a to 200d. In this particular example, the telescope field is divided twice, first by the field divider 320 into four sub-fields, and each sub-field divided up by the image slicer in the respective MICSs 200a to 200d. Additional field dividers may be cascaded as needed and additional MICS included. The image slicer 110 of the MICS would be at the focal point of the telescope 10, either directly or through an optical relay.

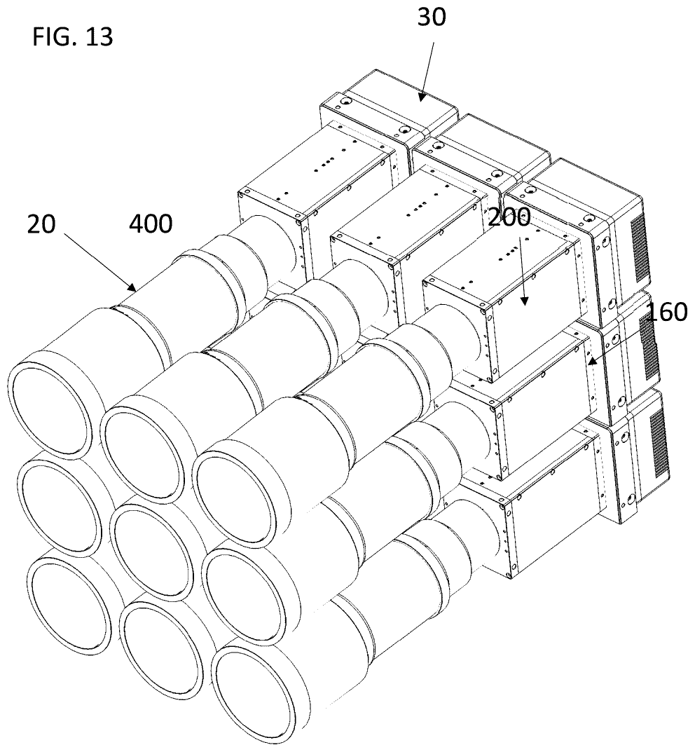

Another way to multiplex to increase the hyperspectral field of view is illustrated in FIG. 13, in which a system 400 includes array of smaller telescopes 20, a corresponding array of MICSs 220 for each telescope 20, and a corresponding array of image sensors 30. Each MICS 220 covers a mosaic field and the mosaic fields of all the MICS are combined together to form the image across the field. Again, the image slicer 110 of the MICS would be at the focal point of each telescope 20, either directly or through an optical relay.

Alternatively, each MICS 200 in the array may include the plurality of MICS 200a to 200d along with a field divider 320 for each telescope 220, i.e., using the system 300 of FIGS. 12. The embodiments in FIGS. 1-13 are disclosed in U.S. application Ser. No. 18/224,594, filed Jul. 21, 2023, the entire contents of which are incorporated herein by reference.

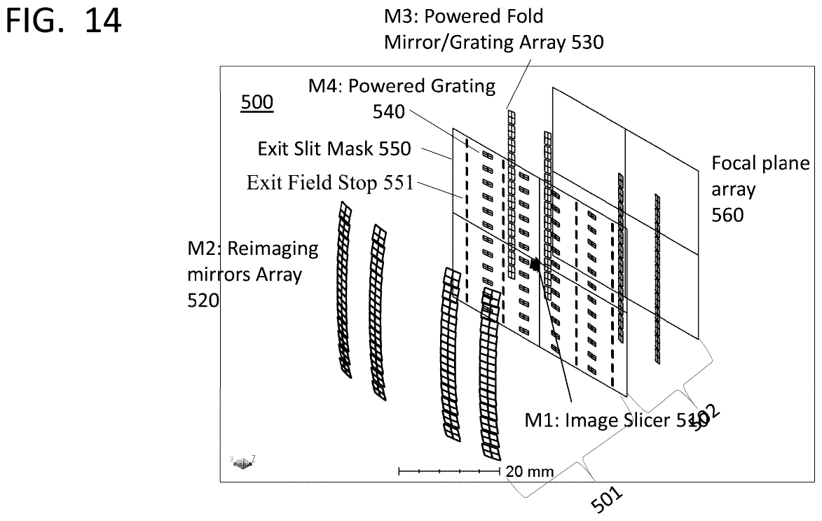

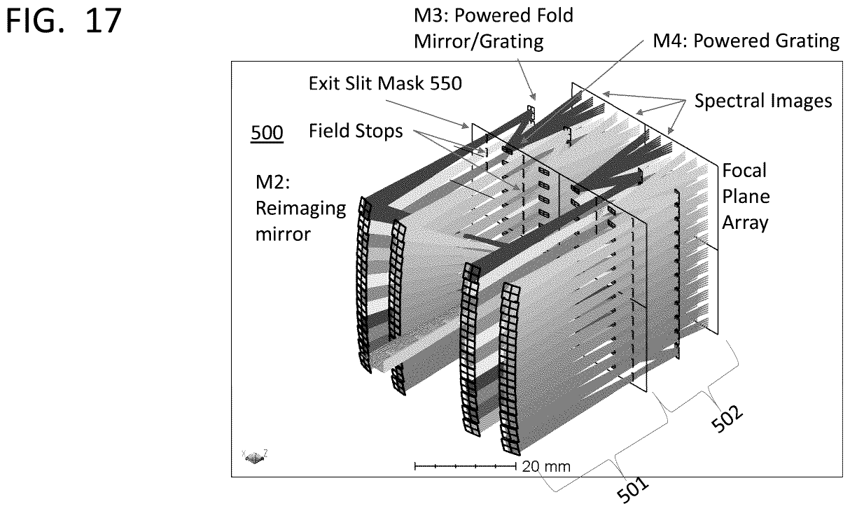

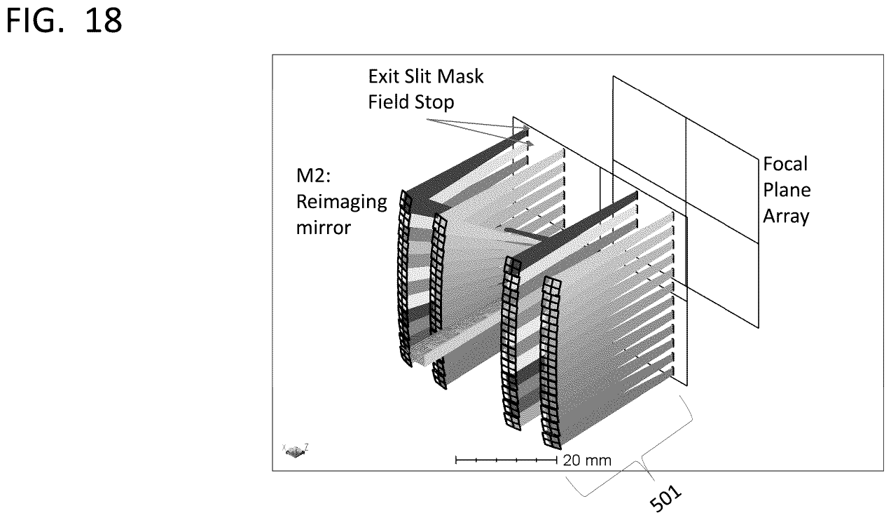

Another configuration of a MICS 500 according to an embodiment is illustrated in FIGS. 14 to 20. As may be seen therein, MICS 500 uses a machined image slicer 510 and reimaging mirror array 520 to reimage the slicer mirrors on a common focal plane, and powered fold mirror array 530 to condition the beam for the powered diffraction grating array 540, which form the spectra of all the slicer mirrors on the final focal plane array 560. An exit slit mask 550 containing a plurality of exit field stops 551, one for each of the image of the slicer mirrors is placed at the common focal plane of the reimaging mirror array 520 to provide scattered light and stray light control.

Thus, the MICS 500 includes two 2-mirror reimaging systems-the 2-mirror Integral Field Unit 501 consists of the image slicer 510, the reimaging mirror array 520, and the exist slit mask 550; and the 2-mirror Spectrograph Array 502 consists of the powered fold mirror array 530 and the powered diffraction grating array 540.

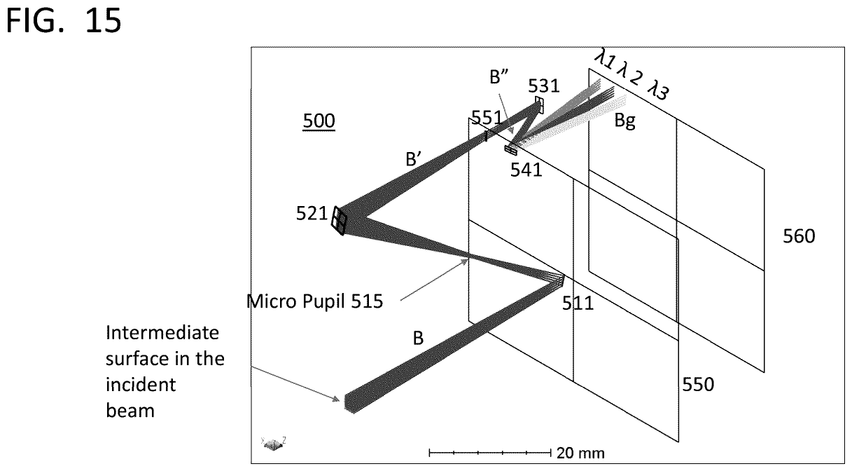

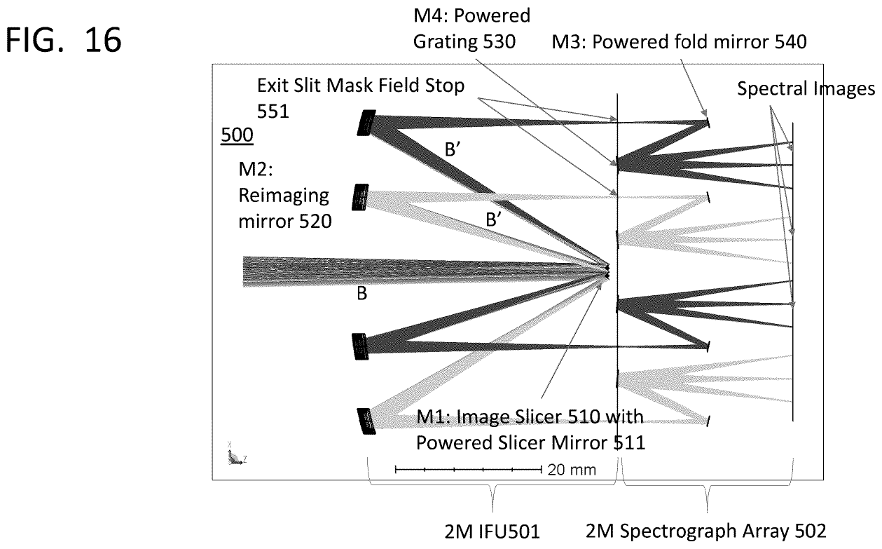

As may be seen in FIGS. 15 and 16, the plurality of slicer mirrors 511 in the image slicer 510 reflects an incoming beam B into a plurality of beams B′ to a plurality of reimaging mirrors 521 of the reimaging mirror array 520, which form an image of the slicer mirrors on a common focal plane. An exit slit mask 550 consists of a plurality of exit field stops 551, one for each of the image of the slicer mirrors, is placed at the common focal plane. The narrow exit slit mask 550 provides effective scattered light and stray light control. Additional baffle systems up-and down-stream of the Exit Field Stop 550 may be implemented to isolate the light path of each miniature spectrograph to further suppress the amplitude of the scattered and stray light in the system.

The slicer mirrors 511 can be flat mirrors or powered. For the 2-mirror IFU 501, the slicer mirrors are cylindrical mirrors with variable radius of curvature in the direction along the long-direction of the slicer mirrors. As shown in FIG. 15, the powered slicer mirrors form a micro pupil (only in the spatial direction) 515 of the optical system approximately halfway between the slicer mirrors 511 and the reimaging mirrors 521. The curvatures of each slicer mirrors 511 are variable, e.g., variable biconic mirrors, depending on the distance between the slicer mirrors 511 and the reimaging mirrors 521, to place the micro pupils at the focus of the off-axis parabolic reimaging mirrors 521, i.e., at the apex of the parabolic mirrors. In other words, the variable curvatures may be optimized for each beam. As a result, the reimaging mirrors 521 condition the reflected beam B′ into telecentric beams.

In the 2-mirror spectrograph array 502, the diverging beams B′ emerging from the exit field stop 551 of the exit slit mask 550 propagate toward the powered fold mirrors 531 in the fold mirror array 530, which in turn condition the diverging beams B′ into collimated or partially collimated beams B″ and directs the conditioned beams onto the micro-gratings 541, which form the spectra of each beam in the final common focal plane of the spectrograph 560.

The 2-mirror IFU 501 may be constructed as a monolithic unit on a transmissive optical substrate such as indium phosphate, calcium fluoride (CAF2), N-BK7 optical glass, or optical plastics such as acrylic, making it an immersive IFU, i.e., in which the optical paths starting from an intermediate surface in the incident beam B to the common focal plane at the exit slit mask 550 may be in a medium other than air.

The 2-mirror spectrograph 502 may be an immersion spectrograph, i.e., in which at least the dispersion elements, or both the collimator mirrors 530 and the grating array 540 are immersed in a medium other than air.

The MICS 500 may be an immersive integral field spectrograph by enclosing the whole unit in high-index liquid, starting with an optical window at an intermediate surface in the incident beam to a second optical window located at a plane right before the final focal plane 560.

In the 2-mirror spectrograph array, a third mirror M3 (powered fold mirror 531) conditions the beam and a fourth mirror M4 is a powered grating 541 that serve as a 2-mirror spectrograph for each slicer beam, as shown in detail in FIGS. 15, 16, and 19. Both M3 and M4 are powered and either one or both of M3 and M4 may provide dispersion, e.g., both may be gratings to form a cross dispersed spectrograph. Each of the 2-mirror reimaging systems may have a same nominal magnification, e.g., 1. The magnification may be substantially different from 1 in other embodiments. The 2M spectrographs 502 may have different magnification in the X and Y (spectral or horizontal and spatial or vertical) direction.

As may be seen in the of FIG. 15, the micro-gratings 541 diffract each of the (partially) collimated beams B′into a continuous spectrum. FIG. 15 represents this spectrum by a plurality of constituent light beams λ1 to An, e.g., three (red, green, blue) for white light, which are then separately focused as beam Bg on the focal plane array 560. Again, the particular design of the image slicer 510 will be dictated by the arrangement of these other components of the MICS 500 as well a focal plane size of the focal plane array 560.

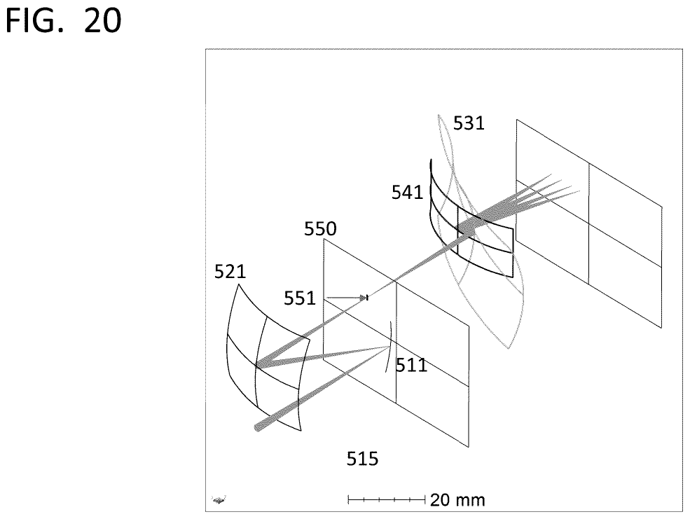

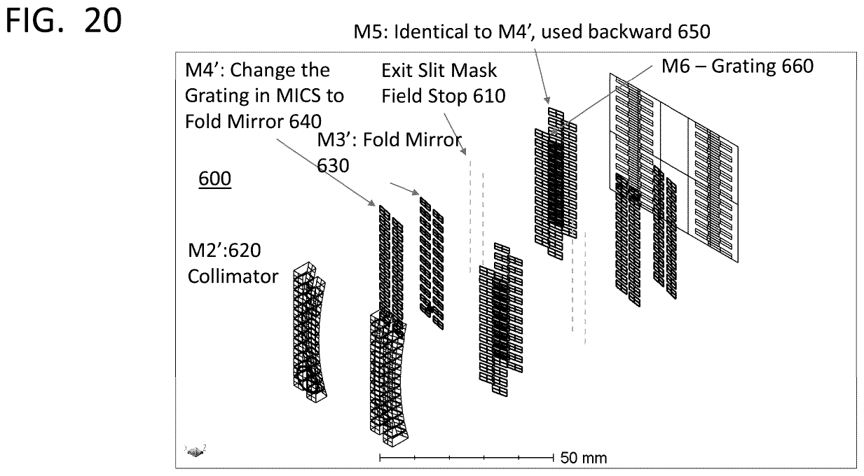

FIG. 20 illustrates a particular embodiment of the 2-mirror spectrograph array of a MICS similar to FIG. 15. The sizes of the four mirrors (511, 521, 531, and 541) are enlarged to clearly show their shapes, and only the chief ray of the field point from the center of the field is shown. As can be seen, the slicer mirror 511 is curved in the long direction of the slicer mirror; and the re-imaging mirror 521 is an off-axis parabola. For the unit spectrograph, the powered fold mirror 531 is concave in the spectral direction, and convex in the spatial direction, such that collimation is realized only in the spatial direction; and the grating 541 is a toroidal grating with concave surface in the spectral direction, and flat (infinite radius) in the spatial direction. The curved surface of the grating may be an off-axis section of a conic surface.

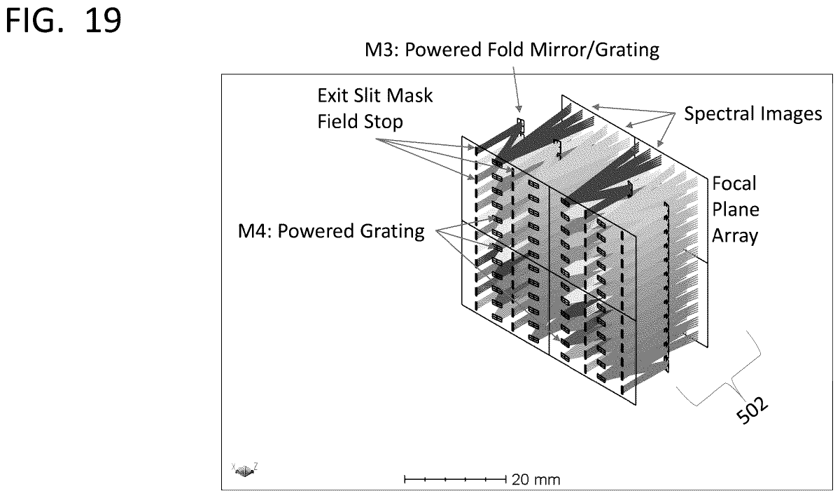

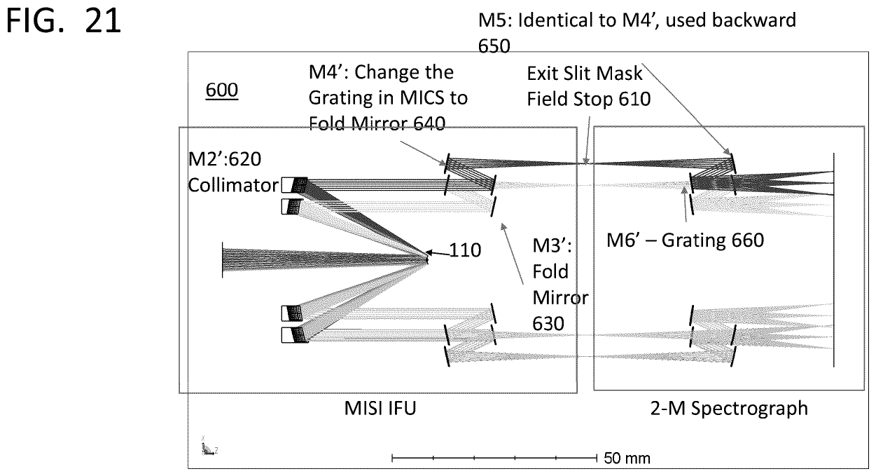

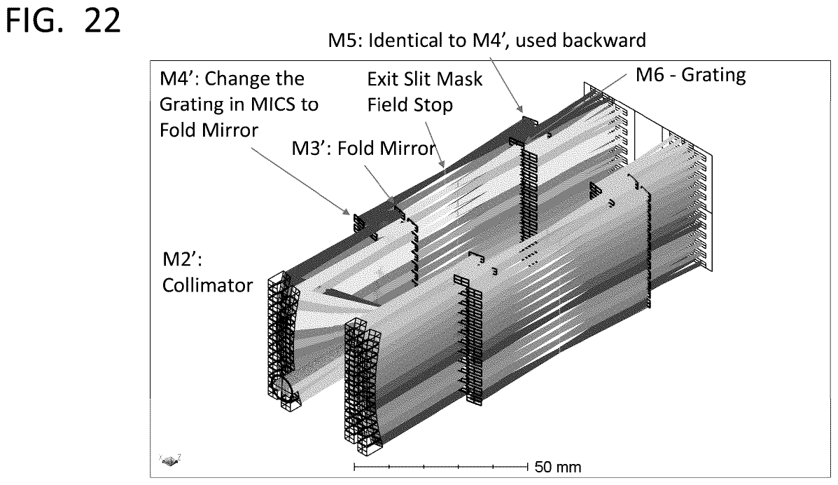

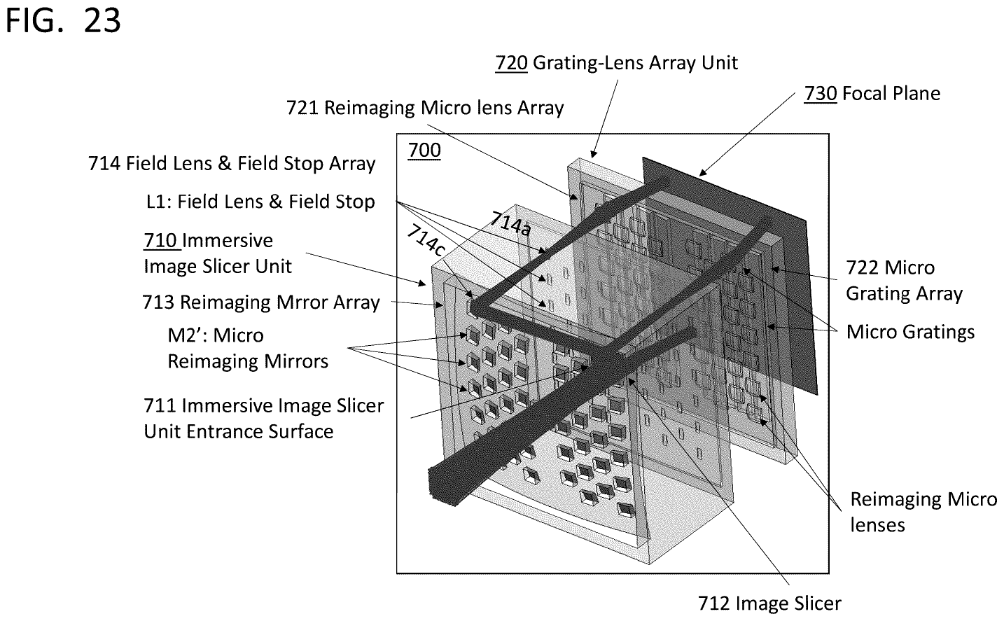

Another configuration of a MICS 600 according to an embodiment is illustrated in FIGS. 21 to 22. As may be seen therein, the MICS 600 is a six mirror configuration. The first portion of the MICS 600 consisting of mirrors M1, M2′, M3′ and M4′ basically corresponds to the MISI of FIG. 1, except with collimator mirrors 620. A second portion of the MICS 600 consists of a two mirror spectrograph, i.e., mirrors M5 and M6, and basically correspond to FIG. 19. A narrow slit mask 610 is provided at each image of the image slicer 110 to control stray light downstream, i.e., between the first and second portions of the MICS 600.

In particular, MICS 600 includes the image slicer 110 (M1), collimator mirrors 620 (M2′), fold mirrors 630 (M3′), reimaging or camera mirrors 640 (M4′), exit slits 610, collimating mirrors 650 (M5), and micro-gratings 660 (M6). Mirror 650 may be the same as mirror 640 but used backwards.

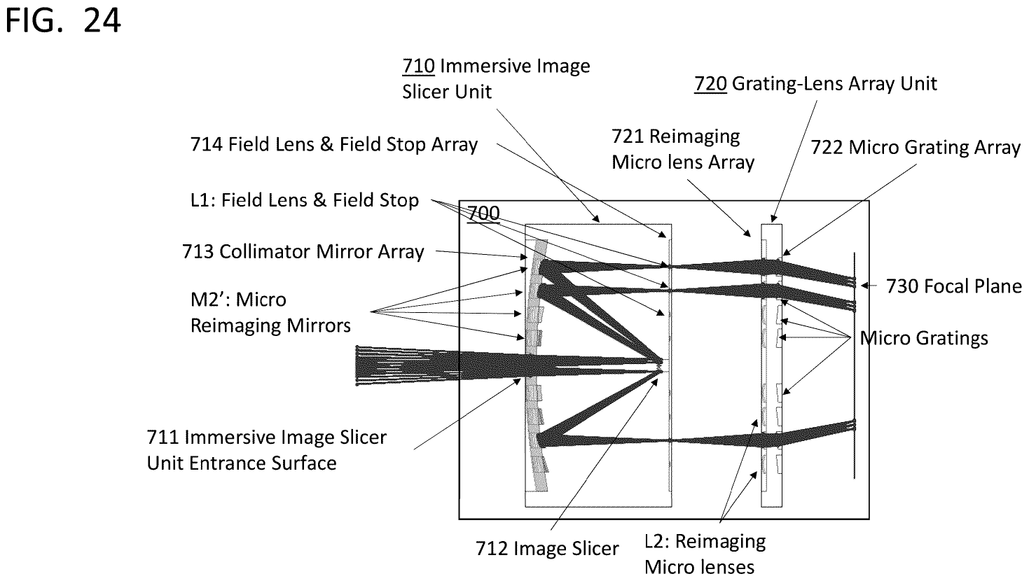

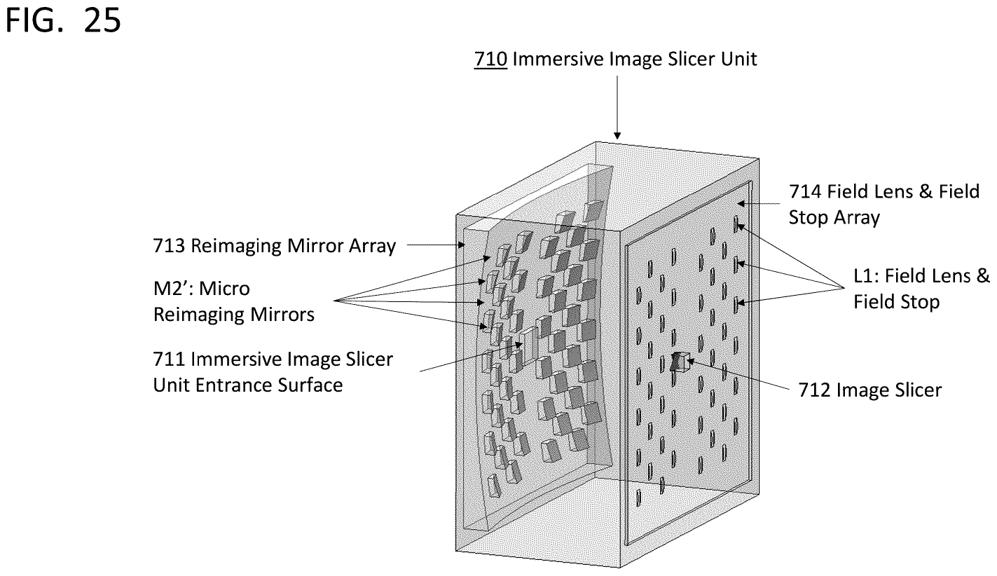

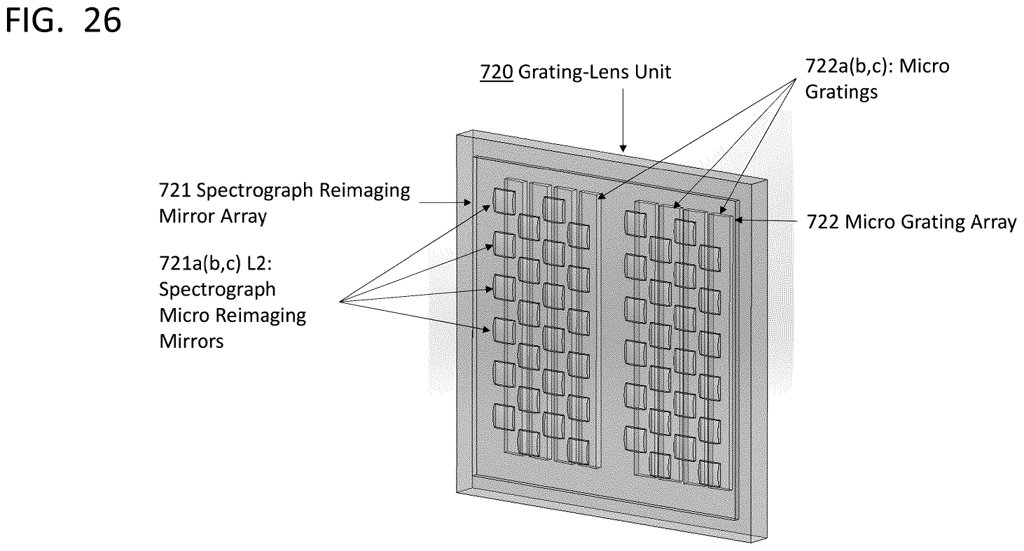

FIGS. 23 and 24 shows an embodiment of an immersive MICS iMICS) 700. As may be seen therein, iMICS 700 includes an immersive image slicer unit or immersive MISI (iMISI) 710 and a grating-lens unit or transmissive grating lens array (tGLA) 720 (together with the sensor serving as the two-mirror spectrograph). The iMISI 710 includes an image slicer 712, a reimaging mirror array 713, and a micro field lens array 714 that may be fabricated on a monolithic transparent optical substrate, with an entrance surface 711. The tGLA 720 includes a reimaging micro lens array 721 and a micro-grating array 722, which may be fabricated on a monolithic transparent optical substrate. In this configuration the spectrograph operates in partial immersive mode. In particular, both the immersive IFU and the transmissive grating lens tGLA may be any suitable material for wavelengths of interest and may be molded with resin, or machined from a bulk monolithic substrate, or a combination of molding, machining, and replicating. The use of immersive and transmissive design increases the F/# of the beams in the high index substrate as compared to the free space designs discussed previously, i.e., resulting in improved optical performance. This design strategy can also be used to increase the number of micro spectrographs given a fixed focal plane size, or to increase the numerical aperture of the system to improve measurement signal-to-noise ratio (SNR). Also, once fabricated, the use of transmissive designs reduces final alignment issues. The details of the iMISI 710 and the tGLA 720 are shown in FIGS. 25 and 26, respectively.

Similar to the embodiment 500 shown in FIG. 16, light enters the immersive image slicer unit 710 through a first entrance surface 711 and forms an image of the target on the image slicer 712. The field is sliced into small narrow sections by the image slicer 712 and directed toward the reimaging mirrors M2′ in the reimaging mirror array 713. The fields are refocused on micro field lenses 714a(b,c . . . ) of the field lens and field stop array 714 on the exit surface of the immersive image slicer unit 710. Except for the micro field lenses 714, the surface area of the exit surface is coated with opaque coating to prevent upstream scattered light from propagating beyond the field lens and field stop array 714.

The micro field lenses 714a(b,c . . . ) condition the beam exiting the image slicer unit 710 to minimize the beam footprint on the micro grating-lenses of the grating-lens unit 720.

The grating-lens array unit 720 includes a reimaging micro lens array 721 to focus the image of the slicer mirrors located at the exit field lens and field stop 714 on the final focal plane 730 of the instrument. The micro grating array 722 includes micro gratings 722a(b,c . . . ) that disperse the light and form the spectra of each subfield on the final focal plane 730.

As would be apparent to one of skill in the art, the free space design and the immersive/transmissive design may be used in various combinations, i.e., any of the IFU designs of FIGS. 14-22 can be used with the two-mirror spectrograph of FIGS. 23-24 and any of the two-mirror spectrograph designs of FIGS. 14-22 can be used with the IFU design of FIGS. 23-24.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure.

1. A machined image slicer compact spectrograph (MICS) for use with a multispectral light source, comprising:
a two-mirror integral field unit, including
an image slicer having a plurality of slicer mirrors to receive light from the multispectral light source and output a plurality of diverging light beams;
a plurality of reimaging mirrors to output an image of each slicer mirror onto an exit slit mask; and
an exit slit mask containing a plurality of exit field stops, one for each of the image of the slicer mirrors; and
a micro spectrograph array, including
a plurality of powered optics receiving light from the plurality of exit field stops; and
a plurality of powered diffraction grating to output an image of each slicer mirror onto an image sensor.

2.-3. (canceled)

4. The MICS according to claim 1, wherein each slicer mirror of the plurality of slicer mirrors form a micro pupil in between the slicer mirrors and the reimaging mirrors.

5.-6. (canceled)

7. The MICS according to claim 5, wherein each slicer mirror of the plurality of slicer mirrors form a micro pupil on the corresponding off-axis parabolic reimaging mirror the plurality of off-axis parabolic reimaging mirrors.

8. The MICS according to claim 1, wherein a plurality of field lenses is placed at the images of each slicer mirror to condition the beams toward the micro spectrograph array.

9. The MICS according to claim 8, wherein the plurality of field lenses have variable curvatures each optimized for each beam.

10. The MICS according to claim 8, wherein the plurality of field lenses is biconic lenses with variable curvatures each optimized for each beam.

11. The MICS according to claim 1, wherein each powered diffractive grating of the plurality of powered diffractive gratings is a toroidal grating.

12.-13. (canceled)

14. The MICS according to claim 1, wherein the two-mirror integral field unit is an immersive integral field unit.

15. The MICS according to claim 14, wherein the immersive integral field unit is monolithic and on a transparent substrate.

16. The MICS according to claim 14, wherein the micro spectrograph array is a free-space spectrograph.

17. The MICS according to claim 16, wherein in the free-space spectrograph, each of the plurality of powered optics is a fold mirror.

18. The MICS according to claim 17, wherein each of the plurality of fold mirrors is concave in the spectral direction and convex in the spatial direction.

19. The MICS according to claim 17, wherein each powered diffractive grating of the plurality of powered diffractive gratings is a toroidal grating.

20. The MICS according to claim 14, wherein the micro spectrograph array is a transmissive spectrograph.

21. The MICS according to claim 1, wherein the two-mirror integral field unit is a free-space integral field unit.

22. The MICS according to claim 21, wherein the micro spectrograph array is a transmissive spectrograph.

23. The MICS according to claim 21, wherein the micro spectrograph array is a free-space spectrograph.

24. The MICS according to claim 23, wherein in the free-space spectrograph, each of the plurality of powered optics is fold mirrors.

25. The MICS according to claim 24, wherein each of the plurality of fold mirrors is concave in the spectral direction, and convex in the spatial direction.

26. The MICS according to claim 21, wherein each powered diffractive grating of the plurality of powered diffractive gratings is a toroidal grating.
